(19) United States
(12) Patent Application Publication
(10) Pub. No.: US 2013/0101345 A1
(43) Pub. Date: Apr. 25, 2013

(54) Integral bicycle crossbar

(71) Applicant: Ming-Jen Wang, Changhua (TW)

(72) Inventor: Ming-Jen Wang, Changhua (TW)

(21) Appl. No.: 13/279,436

(22) Filed: Oct. 24, 2011

(51) Int. Cl. B62K 21/18

(52) U.S. Cl. 403/385

(57) ABSTRACT

An integral bicycle crossbar formed of titanium alloy is provided with a hollow rear bar clamp comprising an upper fastening unit including a first hole, a first threaded hole opposing the first hole, and a first gap separating the first hole from the first threaded hole; and a lower fastening unit including a second hole, a second threaded hole opposing the second hole, and a second gap separating the second hole from the second threaded hole; a front clamp member comprising a half-circular element and four third threaded holes at four corners of the half-circular element respectively; and a bar element having both ends permanently secured to the front clamp member and the hollow rear bar clamp respectively. The upper fastening unit is not longitudinally aligned with the lower fastening unit.

### BACKGROUND OF THE INVENTION

1. Field of the Invention

The invention relates to bicycle components and more particularly to an integral bicycle crossbar made of titanium alloy.

2. Description of Related Art

A conventional bicycle crossbar comprises a front bar clamp releasably secured to a handlebar, a rear bar clamp releasably secured to a seat post, and a bar element having both ends secured to the front and rear bar clamps by soldering.

One drawback of the conventional bicycle crossbar is that the soldering portions are subject to breakage after a period time of use. Thus, the need for improvement still exists.

### SUMMARY OF THE INVENTION

It is therefore one object of the invention to provide an integral bicycle crossbar formed of titanium alloy comprising a hollow rear bar clamp comprising an upper fastening unit including a first hole, a first threaded hole opposing the first hole, and a first gap separating the first hole from the first threaded hole; and a lower fastening unit including a second hole, a second threaded hole opposing the second hole, and a second gap separating the second hole from the second threaded hole; a front clamp member comprising a half-circular element and four third threaded holes at four corners of the half-circular element respectively; and a bar element having both ends permanently secured to the front clamp member and the hollow rear bar clamp respectively; wherein the upper fastening unit is not longitudinally aligned with the lower fastening unit.

The above and other objects, features and advantages of the invention will become apparent from the following detailed description taken with the accompanying drawings.

### BRIEF DESCRIPTION OF THE DRAWINGS

FIG. 1 is a perspective view of a bicycle crossbar according to the invention;

FIG. 2 is a fragmentary view of the front mated clamp member and a portion of the bar element adjacent thereto;

FIG. 3 is a schematic longitudinal sectional view of FIG. 1; and

FIG. 4 is a perspective view of the crossbar mounted with both a seat post and a handlebar.

### DETAILED DESCRIPTION OF THE INVENTION

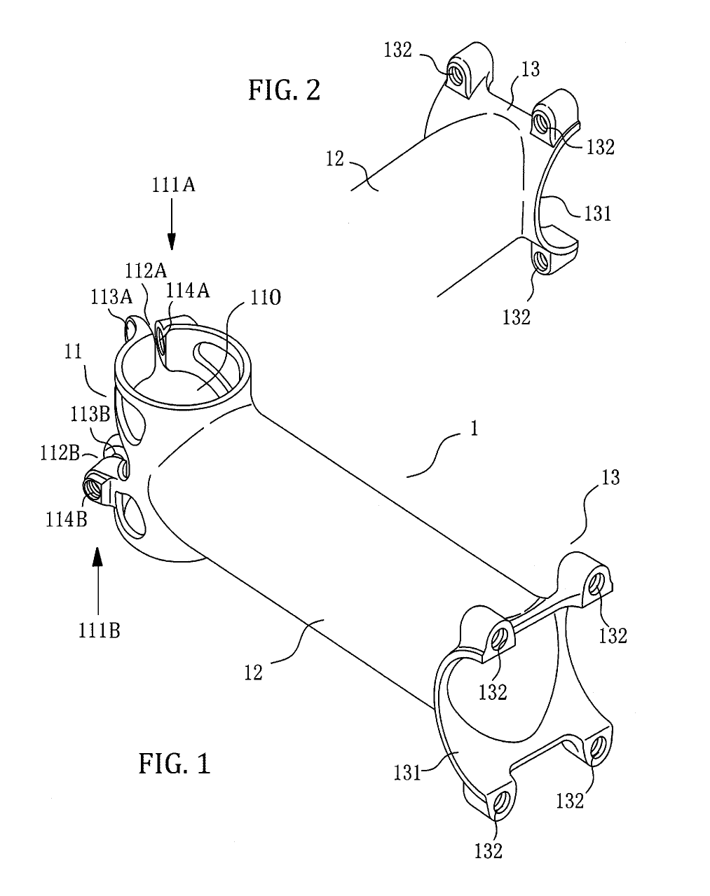

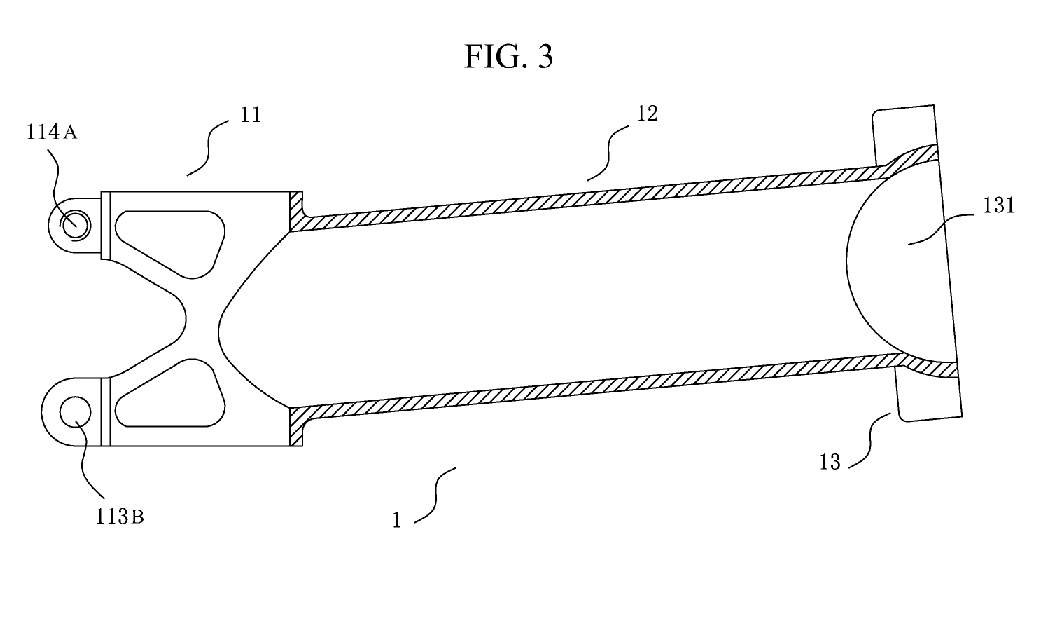

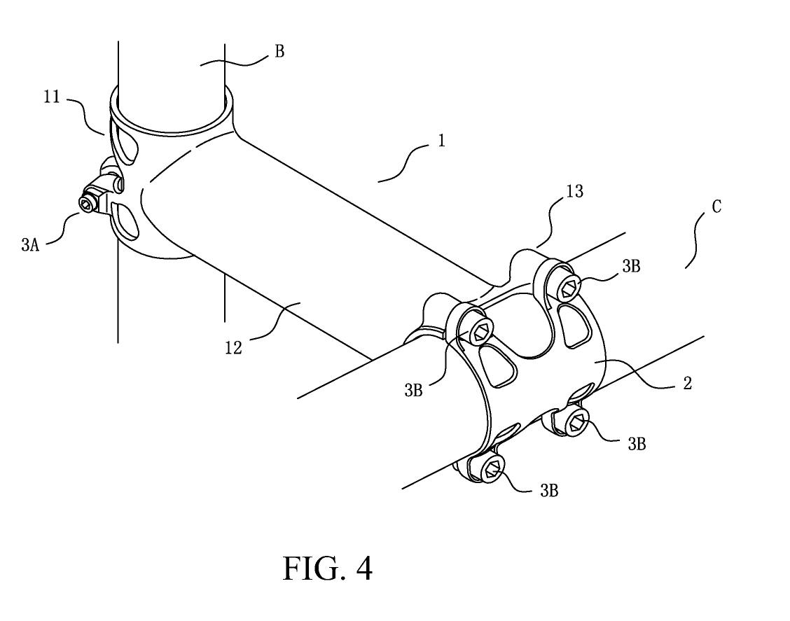

Referring to FIGS. 1 to 4, a bicycle crossbar 1 in accordance with the invention is shown. The crossbar 1 is formed integrally and made of titanium alloy. The crossbar 1 comprises the following components as discussed in detail below.

A rear bar clamp 11 is hollow cylinder and comprises a longitudinal bore 110; a first fastening unit 111A on an upper portion of an outer surface of the rear bar clamp 11 and including a hole 113A, a threaded hole 114A opposing the hole 113A, and a gap 112A separating the hole 113A from the threaded hole 114A; and a second fastening unit 111 B on a lower portion of the outer surface of the rear bar clamp 11 and including a hole 113B, a threaded hole 114B opposing the hole 113B, and a gap 112B separating the hole 113B from the threaded hole 114B. The first fastening unit 111A is not longitudinally aligned with the second fastening unit 111B. The rear bar clamp 11 is releasably secured to a seat post B by inserting the seat post B through the bore 110 and clamping together by driving two bolts 3A through the aligned threaded hole 114A and the hole 113A and the aligned threaded hole 114B and the hole 113B respectively.

A front mated clamp member 13 includes a half-circular element 131 and four threaded holes 132 at four corners of the half-circular element 131 respectively. The front mated clamp member 13 together with a corresponding half-circular, mated clamp member 2 is releasably secured to a handlebar C by inserting therethrough and clamping together by driving four screws 3B through four holed corners of the corresponding half-circular, mated clamp member 2 into the threaded holes 132 of the front mated clamp member 13 respectively.

A hollow bar element 12 has both ends permanently secured to the front mated clamp member 13 and the rear bar clamp 11.

It is envisaged by the invention that the bicycle crossbar 1 has the advantages of having very high tensile strength and toughness and having extraordinary corrosion resistance, and being light weight.

While the invention has been described in terms of preferred embodiments, those skilled in the art will recognize that the invention can be practiced with modifications within the spirit and scope of the appended claims.

What is claimed is:

1. An integral bicycle crossbar formed of titanium alloy comprising:
a hollow rear bar clamp comprising an upper fastening unit including a first hole, a first threaded hole opposing the first hole, and a first gap separating the first hole from the first threaded hole; and a lower fastening unit including a second hole, a second threaded hole opposing the second hole, and a second gap separating the second hole from the second threaded hole;
a front clamp member comprising a half-circular element and four third threaded holes at four corners of the half-circular element respectively; and
a bar element having both ends permanently secured to the front clamp member and the hollow rear bar clamp respectively;
wherein the upper fastening unit is not longitudinally aligned with the lower fastening unit.
